(19) United States
(12) Patent Application Publication
(10) Pub. No.: US 2024/0345207 A1
(43) Pub. Date: Oct. 17, 2024

(54) METHODS AND SYSTEMS FOR DETERMINING POSITION AND ORIENTATION OF A DEVICE USING LIGHT BEACONS

(71) Applicant: Bose Corporation, Framingham, MA (US)

(72) Inventor: Miguel Alejandro Chavez-Salas, Cambridge, MA (US)

(21) Appl. No.: 18/633,689

(22) Filed: Apr. 12, 2024

Related U.S. Application Data
(60) Provisional application No. 63/459,366, filed on Apr. 14, 2023.

(51) Int. Cl. G01S 5/16; H04R 1/10; H04R 5/033; H04S 7/00

(52) U.S. Cl. CPC G01S 5/16; H04R 1/1041; H04R 5/033; H04S 7/304; H04S 2400/11

(57) ABSTRACT

A wearable audio device includes a light angle sensor that is configured to measure respective angles of incidence of a pair of light beams emitted by respective light beacons associated with a source device. The wearable audio device is configured to use the measured angles of incidence for spatial audio rendering.

### PRIORITY CLAIM

This application claims priority to U.S. Patent Application No. 63/459,366, filed Apr. 14, 2023, wherein the entire contents of the aforementioned application are hereby incorporated by reference.

### BACKGROUND

Aspects and implementations of the present disclosure relate to audio systems, specifically, to audio systems which include one or more wearable device and one or more audio source. Some wearable devices, such as headphones or smart glasses, may utilize a collection of sensors, referred to as an inertial measurement unit (IMU) to derive relative position and/or orientation of the device with respect to a fixed point in space.

### SUMMARY OF THE DISCLOSURE

The present disclosure relates to systems and methods for determining the position and orientation of a wearable audio device, for example, methods and systems for determining the position and orientation of a wearable audio device relative to a source device using light beacons (e.g., infrared (IR) light beacons). In some examples, the determined position and orientation can be utilized to determine head related transfer functions (HRTFs), which, in turn, can be used to process an audio signal provided by the source device to provide spatialized audio (e.g., an externalized or virtualize audio source) at the wearable device. Thus, the systems and methods described herein can be utilized to generate a virtual audio source via the wearable audio device by first determining its own absolute position and orientation relative to a source device using light beacons.

In one aspect, a wearable audio device includes a light angle sensor that is configured to measure respective angles of incidence of a pair of light beams emitted by respective light beacons associated with a source device. The wearable audio device is configured to use the measured angles of incidence for spatial audio rendering.

Implementations may include one of the following features, or any combination thereof.

In some implementations, the wearable audio device is configured to use the measured angles of incidence for detecting the absolute position of the source device.

In certain implementations, the source device is a playback device.

In some cases, the wearable audio device is configured to use the measured angles of incidence for detecting a position of the light angle sensor relative to an absolute location within an acoustical space to render physically or psychoacoustical accurate audio queues.

In certain cases, the wearable audio device is configured to use the measured angles of incidence for object oriented spatial audio rendering (placing objects (virtual audio sources) in an absolute place relative to the beacons).

In another aspect, a system includes a source device with a pair of light beacons, and a wearable audio device that is configured to receive an audio signal from the source device. The wearable audio device is configured to process the audio signals based, at least in part, on information derived from light beams emitted by the light beacons.

Implementations may include one of the above and/or below features, or any combination thereof.

In some implementations, the source device includes three light beacons for 3-dimensional sensing.

In certain implementations, the light beacons are infrared light emitters.

In some cases, the light beacons are arranged a fixed distance from each other on the source device.

In some examples, the source device is a soundbar.

In certain examples, the system is a conferencing system.

In some implementations, the source device is a display (e.g., a monitor or television).

In certain implementations, the system is an aviation system.

In some cases, the source device is an instrument panel within a cockpit of an aircraft.

In certain cases, the system is disposed within an automobile.

In some examples, the system is a gaming system.

According to another aspect, a system includes a wearable device a wearable audio device that includes a light angle sensor, and a source device that is configured to transmit an audio signal to the wearable audio device. The wearable audio device is configured to process the audio signal based, at least in part on information derived from the light angle sensor to provide spatial audio rendering.

Implementations may include one of the above and/or below features, or any combination thereof.

In some implementations, the wearable audio device includes an open-ear earbud.

In certain implementations, the light angle sensor is supported on the open-ear bud.

In some cases, the wearable audio device includes headphones. The headphones include a pair of earcups connected to each other by a band.

In certain cases, the light angle sensor is designed into one of the earcups.

In some examples, the light angle sensor is designed into the band.

In certain examples, the wearable audio device is configured to derive angle information from the light angle sensor.

In some implementations, the source device includes a first light beacon and a second light beacon, and the derived angle information includes a first angle of incidence between the light angle sensor and a first light beam emitted by the first light beacon and a second angle of incidence between the light angle sensor and a second light beam emitted by the second light beacon.

In yet another aspect features a method that includes detecting, at a light angle sensor of a wearable audio device, an angle of incidence of a first light beam emitted from a first light beacon of a source device and an angle of incidence of a second light beam emitted from a second light beacon of the source device. The method also includes determining, via a processor of the wearable audio device, an absolute position (distance) and a head orientation of a user relative to the source device based on the detected incident angles and a known distance between the first and second light beacons. A head related transfer function (HRTF) is determined, using the processor, based on the determined absolute position (distance) and head orientation (pan angle). The audio signal is processed using the HRTF to provide a processed audio signal; and the processed audio signal is transduced to acoustic energy using one or more transducers of the wearable audio device to provide spatialized audio that is perceived by the user as originating from one or more virtual audio sources.

Implementations may include one of the above and/or below features, or any combination thereof.

In some implementations, the method also includes transmitting the audio signal to the wearable audio device from the source device.

In certain implementations, location data is transmitted from the source device to the wearable audio device, wherein the location data corresponds to an intended location of the one or more virtual audio sources relative to the source device.

In some cases, the location data includes object metadata for object-oriented audio rendering.

In some examples, the method is performed contemporaneously for each of two earpieces of the wearable audio device. Each earpiece may be provided with a corresponding light angle sensor, processor, memory, and transducer. In certain examples, the first and second light beams are infrared (IR) light beams.

In some implementations, each of the first and second light beacons emits light with a different carrier frequency.

In certain implementations, the method includes detecting a loss in line of sight between the light angle sensor and at least one of the light beacons, and, in response, processing, with the processor, a sensor signal from an IMU of the wearable audio device to measure head movements and using the measured head movements to determine one or more additional HRTFs until the line of sight between the light angle sensor and the two light beacons is re-established.

According to another aspect, a system includes a wearable audio device that includes a pair of light beacons, and a source device that includes a light angle sensor that is configured to measure respective angles of incidence of a pair of light beams emitted by the light beacons. The system is configured to process an audio signal using head related transfer functions (HRTFs) that are determined based, at least in part on information derived from the light angle sensor to provide spatial audio rendering.

Implementations may include one of the above and/or below features, or any combination thereof.

In some implementations, the source device is configured to transmit the audio signal to the wearable audio device.

In certain implementations, the wearable audio device is configured to process the audio signal using the HRTFs to produce processed audio signals and transduces the processed audio signals to acoustic energy.

In some cases, the source device is configured to determine the HRTFs.

In certain cases, the source device is configured to process the audio signal using the HRTFs and provides processed audio signals to the wearable audio device for transduction to acoustic energy.

In some examples, the source device is configured to share information regarding a detected absolute position and/or measured incident angles with the wearable audio device so that the wearable audio device can determine the HRTFs based on the shared information.

In certain examples, the source device is configured to determine the HRTFs and provides those to the wearable audio device.

In yet another aspect, a system includes a wearable device, and a plurality of spaced light beams that are detected that allow the wearable device to determine: (i) distance, (ii) horizontal tilt and (iii) vertical tilt to the beams OR an absolute location relative to the beam placement. The system is configured to use the information determined from the light beams for spatial audio rendering.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a system according to the present disclosure.

FIG. 2A is a schematic representation of the components of an earpiece of a wearable audio device according to the present disclosure.

FIG. 2B is a schematic representation of the components of a wearable audio device according to the present disclosure.

FIG. 2C is a schematic representation of the components of an audio source device according to the present disclosure.

FIG. 3A is a top plan schematic view of a system according to the present disclosure.

FIG. 3B is a top plan schematic view of a system according to the present disclosure.

FIGS. 4A & 4B illustrate the steps of a method according to the present disclosure.

### DETAILED DESCRIPTION OF EMBODIMENTS

The present disclosure relates to systems and methods for determining the absolute position (distance) and orientation (head pan angle) of a wearable audio device, for example, methods and systems for determining the position and orientation of a wearable audio device relative to a source device using light (e.g., infrared (IR)) beacons). In some examples, the determined position and orientation can be utilized to determine HRTFs for rendering spatialized audio (e.g., one or more virtual audio sources).

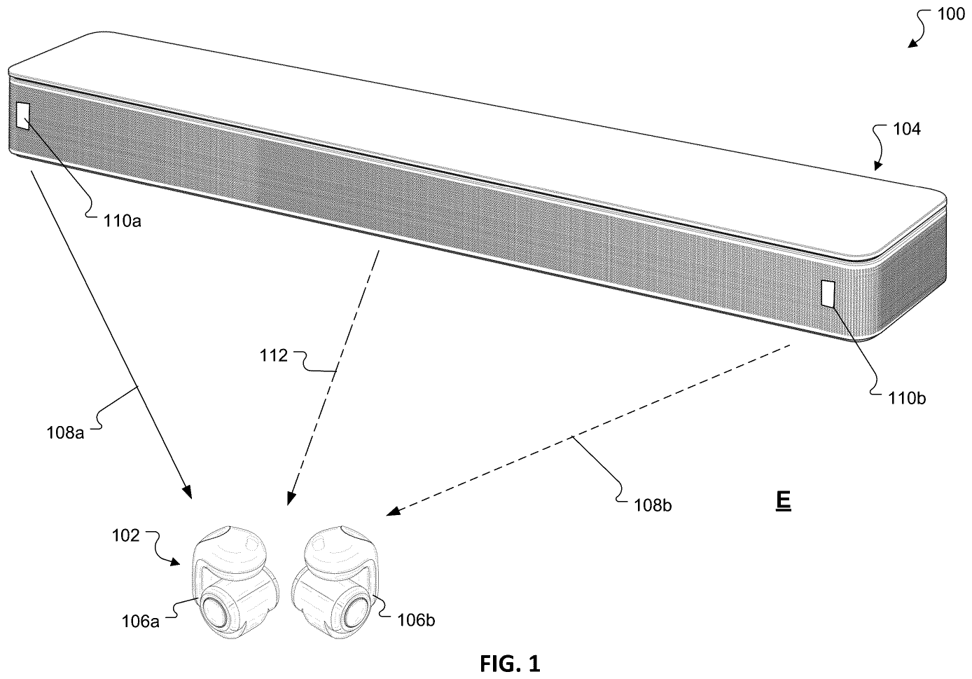

The term “wearable audio device”, as used in this application, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. Wearable audio devices are sometimes referred to as headphones, earphones, earpieces, headsets, earbuds or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of acoustic drivers, it should be appreciated that a wearable audio device can be a single stand-alone unit having only one acoustic driver. Each acoustic driver of the wearable audio device can be connected mechanically to another acoustic driver, for example by a headband and/or by leads that conduct audio signals to the pair of acoustic drivers. A wearable audio device can include components for wirelessly receiving audio signals. A wearable audio device can include components of an active noise reduction (ANR) system. Wearable audio devices can also include other functionality such as a microphone so that they can function as a headset. While FIG. 1 shows an example of an open-ear headset form factor, in other examples the headset may be an in-ear, around-ear, or near-ear headset. In some examples, a wearable audio device may be an open-ear device that includes an acoustic driver to radiate acoustic energy towards the ear while leaving the ear open to its environment and surroundings.

The term “head related transfer function” or acronym “HRTF” as used herein, in addition to its ordinary meaning to those with skill in the art, is intended to broadly reflect any manner of calculating, determining, or approximating the binaural sound that a human ear perceives such that the listener can approximate the sound's position of origin in space. For example, a HRTF may be a mathematical formula or collection of mathematical formulas that can be applied or convolved with an audio signal such that a user listening to the modified audio signal can perceive the sound as originating at a particular point in space. These HRTFs, as referred to herein, may be generated specific to each user, e.g., taking into account that user's unique physiology (e.g., size and shape of the head, ears, nasal cavity, oral cavity, etc.). Alternatively, it should be appreciated that a generalized HRTF may be generated that is applied to all users, or a plurality of generalized HRTFs may be generated that are applied to subsets of users (e.g., based on certain physiological characteristics that are at least loosely indicative of that user's unique head related transfer function, such as age, gender, head size, ear size, or other parameters). In one example, certain aspects of the HRTFs may be accurately determined, while other aspects are roughly approximated (e.g., accurately determines the inter-aural delays, but coarsely determines the magnitude response).

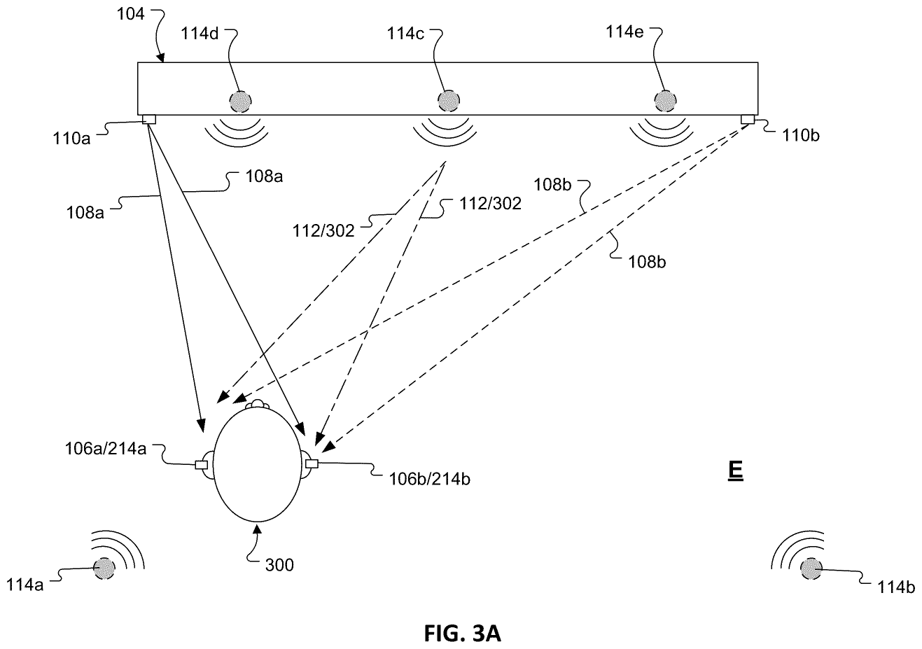

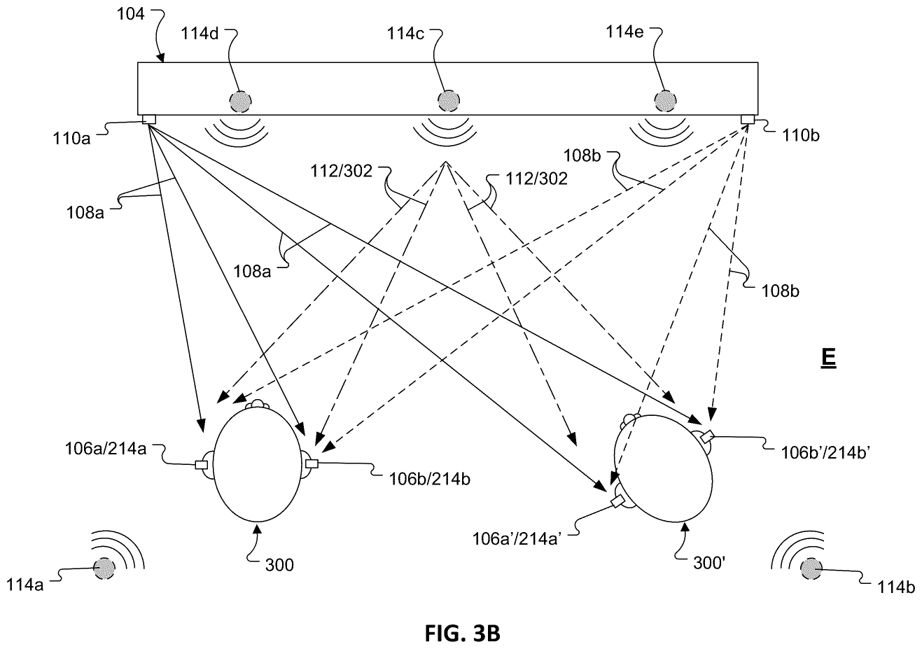

The following description should be read in view of FIGS. 1-3B. FIG. 1 is a schematic view of system 100 employed in an environment E according to the present disclosure. System 100 includes at least one wearable audio device, e.g., wearable audio device 102, and a source device 104. In the illustrated example, the wearable audio device 102 is an open-ear headset that includes a pair of earpieces 106a, 106b (collectively “earpieces 106”). Wearable audio device 102 is intended to be a device capable of sensing (via or more light angle sensors discussed below) light within environment E, e.g., light 108a, 108b (collectively referred to as “beams 108” or “plurality of beams 108”) (shown in FIGS. 3A & 3B) emitted from light beacons 110a, 110b (collectively referred to as “light beacons 110” or “beacons 110”) on the source device 104. The wearable audio device 102 uses sensor signals from the light angle sensors 214 to process an audio signal 112 to make sound be perceived as coming from the location of one or more virtual sound sources (e.g., virtual audio sources 114a-114e) even if nothing is physically producing the sound from said location. Such audio spatialization may be simulated by applying HRTFs to the audio signal. Head related transfer function (HRTFs) may be calculated or stored in a memory that characterize how a user receives sound from various directions. Separate HRTFs may be calculated or provided for each of the left and right ears. A directionality of the sound produced by the sound source varies with an orientation of the user's head, e.g., a head pan angle. At least one example of a system to spatialize audio into one or more virtual audio sources (aka “virtual sound sources”) may be found in in U.S. patent application Ser. No. 16/592,454 filed Oct. 3, 2019, titled “SYSTEMS AND METHODS FOR SOUND SOURCE VIRTUALIZATION.” Additional details regarding the open-ear headset may be found in U.S. Pat. No. 11,140,469, issued Oct. 5, 2021, titled “OPEN-EAR HEADPHONE.”

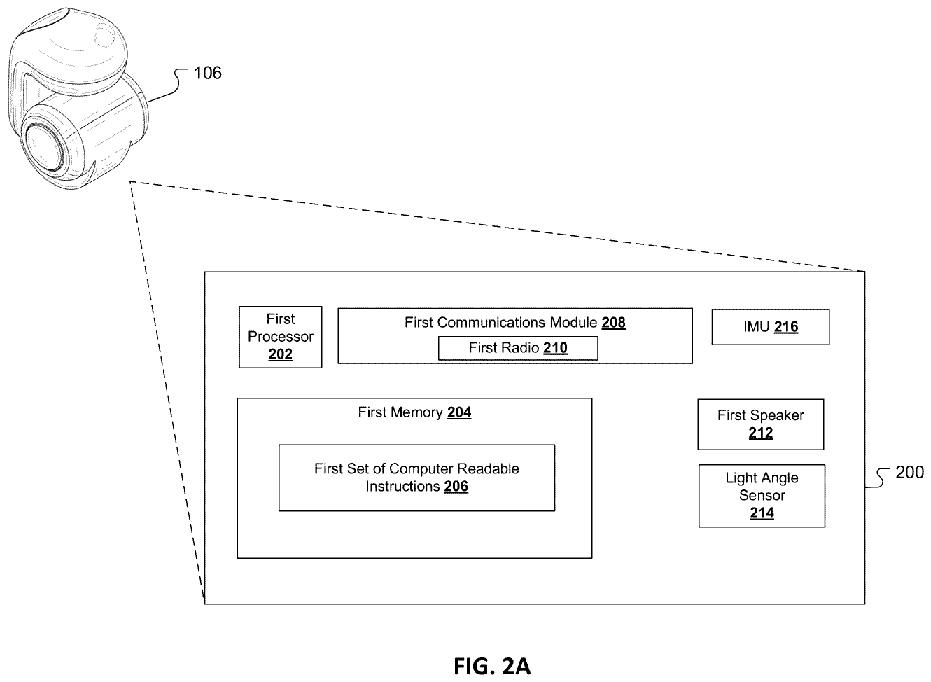

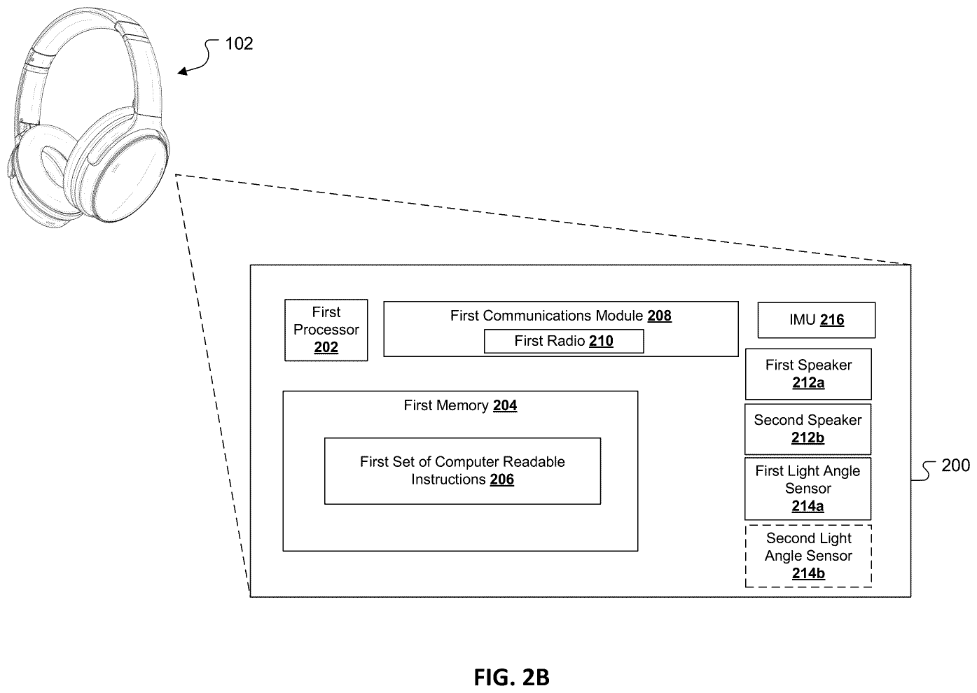

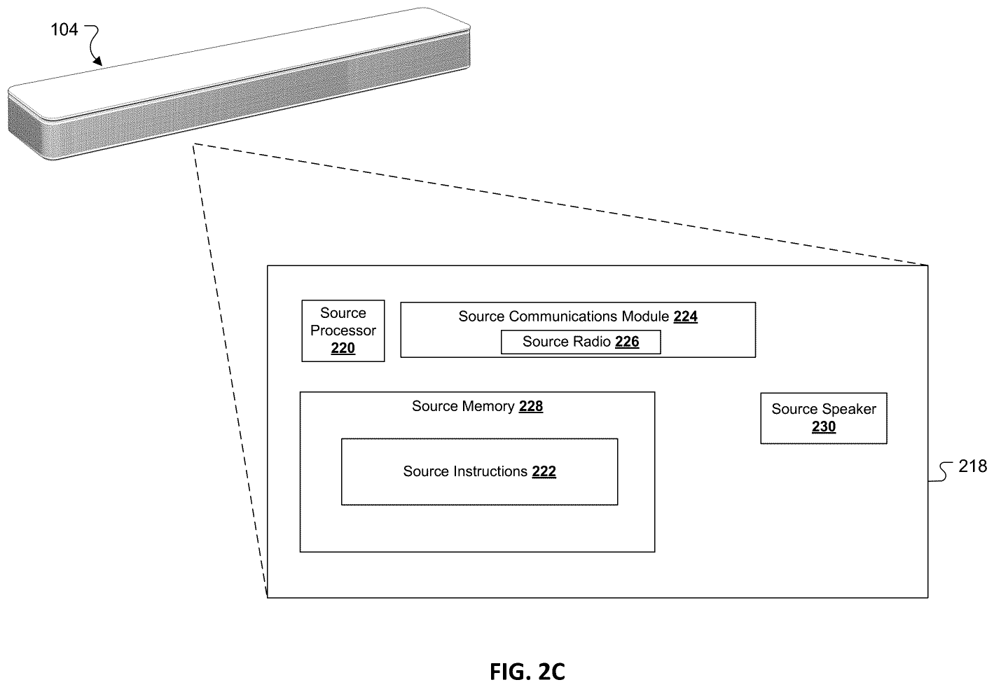

FIG. 2A is a schematic representation of the components of one of the earpieces 106 (e.g., earpiece 106a) of the wearable audio device 102. In some cases, the other earpiece 106 (e.g., earpiece 106b) may include an identical set of components. As illustrated in FIG. 2A, the earpiece 106 can further include first circuitry 200 including a first processor 202 and first memory 204 capable of executing and storing, respectively, a first set of non-transitory computer-readable instructions 206 to perform the functions of wearable audio device 102 as described herein. First circuitry 200 can also include a first communications module 208 configured to send and/or receive wireless data, e.g., data relating to the audio signal 112 (as illustrated in FIG. 1). To that end, first communications module 208 can include at least one radio or antenna, e.g., a first radio 210 capable of sending and receiving wireless data. In some examples, first communications module 208 can include, in addition to at least one radio (e.g., first radio 210), some form of automated gain control (AGC), a modulator and/or demodulator, and potentially a discrete processor for bit-processing that are electrically connected to first processor 202 and first memory 204 to aid in sending and/or receiving wireless data. As will be discussed below, first circuitry 200 of wearable audio device 102 can also include a first speaker 212, e.g., a loudspeaker or acoustic driver or transducer, that is electrically connected to first processor 202 and first memory 204 and configured to electromechanically convert an electrical signal, e.g., audio signal 106, into audible acoustic energy also referred to herein as an audio playback.

Additionally, as will be discussed below, first circuitry 200 of earpiece 106 can further include at least one light angle sensor 214. A suitable light angle sensor is the ADPD2140 infrared light angle sensor available from Analog Devices, of Wilmington, MA. In some examples, each earpiece 106 has only one light angle sensor 214, i.e., first light angle sensor 215. In other examples, each earpiece 106 may comprise a plurality of light angle sensors, e.g., two, three, four, six, eight, etc. As will be discussed below, each light angle sensor 214 is capable of receiving the light emitted by the source device 104 and processing the corresponding sensor signals to determine an absolute position (distance) of the corresponding earpiece 106 relative to the source device 104 as well as head rotation (head pan angle) relative to the light beacons 110.

Additionally, first circuitry 200 of earpiece 106 can further include an inertial measurement unit 216 (shown schematically in FIG. 2A). Inertial measurement unit (IMU) 216 is intended to include one or more sensors configured to obtain a perceived orientation of the wearable audio device 102 relative to the audio source 104 (shown in FIGS. 3A and 3B and discussed below). In some examples, the sensors of IMU 216 can be selected from one or more of: a gyroscope (e.g., a three-axis gyroscope), an accelerometer (e.g., a three-axis accelerometer), a magnetometer, a camera, a proximity sensor, a light detection and ranging sensor (LIDAR), an ultrasonic distance sensor, or any other sensor capable of obtaining relative distance, orientation, position, or height information of the wearable audio device 102 relative to the source device 104. IMU 216 can employ one or more algorithms to process the data obtained from the foregoing sensors to determine the relative perceived position and orientation of wearable audio device 102 relative to the source device 104.

FIG. 2B is a schematic representation of an exemplary wearable audio device having a banded headphone form factor. A banded headphone includes a pair of earcups connected to each other by band. In the illustrated example, the wearable audio device 102 includes a single processor (first processor 202) for processing the audio signal for both earcups. The circuitry 200′ includes a pair of speakers 212a, 212b each of which may be disposed within a corresponding one of the earcups. A pair of light angle sensors 214a, 214b may be provided (one in each earcup) in communication with the processor 202. The first processor 202 can process the audio signal based on signals from both light angle sensors 214a, 214b to provide respective processed audio signals for each of the speakers 212a, 212b to render the spatialized audio. In other implementations, a banded headphone may include a single light angle sensor that is mounted on the band connecting the two earcups and the single processor can process the audio signal (differently for each speaker) based on the input from the single light angle sensor.

As illustrated in FIG. 2C, the source device 104 can also include its own circuitry, i.e., source circuitry 218. The source circuitry 218 of the source device 104 includes a source processor 220 and source memory 228 capable of executing and storing, respectively, a set of non-transitory computer-readable instructions, i.e., source instructions 222, to perform the functions of the source device 104 as described herein. The source circuitry 218 can also include a source communications module 224 configured to send and/or receive wireless data, e.g., data relating to the audio signal 112 to and/or from, e.g., a peripheral device or wearable audio device 102. To that end, the source communications module 224 can include at least one radio or antenna, e.g., a source radio 226, capable of sending and receiving wireless data. In some examples, the source communications module 224 can include, in addition to at least one radio (e.g., source radio 226), some form of automated gain control (AGC), a modulator and/or demodulator, and potentially a discrete processor for bit-processing that are electrically connected to the respective source processor 220 and source memory 228 to aid in sending and/or receiving wireless data. As will be discussed below, the source device 104, and therefore the source circuitry 218 can also include at least one source speaker 230, e.g., a loudspeaker or acoustic driver or transducer, that is electrically connected to its source processor 220 and source memory 228 and configured to electromechanically convert an electrical signal, e.g., audio signal 112, into audible acoustic energy within environment E, also referred to herein as audio playback. In some examples, the audio signal 112 and the audible acoustic energy are associated with the data sent and received between wearable audio device 102, the source device 104.

The system 100 can be configured to generate, create, or otherwise render one or more virtual audio sources within environment E. For example, wearable audio device 102 can be configured to modify the audio signal 106 into one or more modified (processed) audio signals that have been filtered or modified using at least one head-related transfer function (HRTF). In one example of system 100, the system can utilize this virtualization or externalization with augmented reality audio systems and programs by modeling the environment E (e.g., using a localizer or other source of environment data), creating one or more virtual audio sources at various positions within environment E, e.g., virtual audio source(s) 114a-114c (collectively “virtual audio source(s) 114”), and modeling or simulating sound waves and their respective paths from the virtual audio source(s) 114 (shown in FIGS. 3A-3B) to the position of the wearable audio device 102 and/or the position of the user's ears while wearing wearable audio device 102 to simulate to the user perception of sound as though the virtual audio source(s) 114 is/are a real or tangible sound source(s), e.g., a physical speaker located at the position of virtual audio source 114 within environment E. For each modeled or simulated sound path (e.g., direct sound paths or reflected sound paths), computational processing is used to apply or convolve at least one pair of HRTFs (one associated with the left ear and one associated with the right ear) to the audio signal 112 to generate modified audio signals. Once the HRTFs have been applied and the modified audio signals are generated, the modified audio signals can be provided to the speakers 212 of the wearable audio device 102 to generate an audio playback that tricks the user's mind into thinking they are perceiving sound from an actual externalized source located at the position of the virtual sound sources 114 within environment E. Additional information related to generating and simulating virtual sound sources can be found in United States Patent Application Publication No. 2020/0037097, which application is incorporated herein in its entirety.

In one example operation, as illustrated in FIG. 3A, system 100 includes a wearable audio device 102 having two light angle sensors, i.e., first light angle sensor 214a on a first earpiece 106a and a second light angle sensor 214b on a second earpiece 106b, and a source device 104. The source device 104 can send wireless data to the wearable audio device 102. The wearable audio device 102 can receive the audio signal 112 from the source device 104. The wearable audio device 102 can also receive light beams (source beams) 108 from a pair of light beacons 110a, 110b (“light beacons” or “beacons”) supported on the source device 104. The beacons can be light emitting diodes (LED) beacons. The beacons can emit infrared (IR) light. Each beacon can emit light with a different carrier frequency. Using an angle of incidence (aka “angle of incident” or “incident angle”) of each beam, as determined from sensor signals from the light angle sensors 214a, 214b (collectively “214”), and the distance between the light beacons 110, which is predetermined, each earpiece 106 can determine head orientation (“head pan”) relative to the source device 104 and absolute position (distance) from the source device 104. In that regard, earpiece 106a can use the angles of incidence of each of the light beams 108a, 108b, as measured via the light angle sensor 214a, along with the known distance between the beacons 110 to determine absolute position and head orientation. Earpiece 106b can similarly determine absolute position and head orientation using signals from the light angle sensor 214b. The absolute position (distance) can be determined using triangulation. The determined head orientation and distance from the source device 104 can then be used to determine an appropriate HRTF for each earpiece 106. The HRTFs are used to process the reference audio signal in order to render one or more virtual audio sources 114a-114e.

In one example, the source device 104 is a soundbar and the wearable audio device 102 is a pair of open-ear earpieces 106a, 106b (collectively “earpieces 106” or “earbuds 106”). The soundbar can render front left, front right, and front center audio and transmit an audio signal 112 to the earpieces 106 to supplement the soundbar audio with virtualized rear surround (e.g., virtual audio sources 114a and 114b) for providing rear left and rear right audio. That is, the earbuds can use the audio signal 112 from the soundbar to render rear surround audio via virtual surround speakers using the spatial rendering techniques described herein. By tracking the user's head movements via the light angle sensors 214 (and beacons 110) and using the input from the light angle sensors 214 to process the audio signal 112, the virtual speakers 114 can be presented in such a manner that they appear to the user 300 as though they are fixed in space (e.g., such that they do not appear to move relative to soundbar even as the user 300 moves their head). Alternatively, or additionally, the wearable audio device 102 may use the audio signal 112 from the soundbar to render audio in such a manner as to sound to the user 300 as though it is coming from the soundbar itself, i.e., to virtualize one or more speakers (audio sources), e.g., virtual audio sources 114c-4e, at the soundbar. This may be beneficial, for example, to provide individual listeners the ability to listen to the same content (e.g., a movie or television program) at different volumes.

The wearable audio device 102 may be pre-programmed (e.g., may include instructions stored in memory 204 for execution by the processor 202) to render the one or more virtual audio sources 114 in a predetermined position(s) relative to the source device 104. Alternatively, or additionally, the source device 104 may provide location data 302 corresponding to the intended location of the virtual audio source(s) 114 to the wearable audio device 102. The location data may be included in the audio signal or may be provided separately, e.g., in a separate signal. The location data informs the wearable audio device 102 either where to locate the virtual audio source(s) (e.g., a fixed location (e.g., coordinate or vector data) relative to the source device) or it may identify which virtual audio source(s) of one or more predetermined virtual audio source(s) is/are to render the modified (processed) audio signal. For example, the location data may identify a particular audio channel associated with the audio, which the wearable audio device 102 can use to render the audio via a predetermined (preprogrammed) virtual audio source associate with the identified audio channel.

In some cases, the IMU 216 may be used to compensate for head movements during periods when a line of sight between one the light beacons 110a, 110b (collectively light beacons 110″) and the wearable audio device 102 is lost. That is, if the user 300 moves his/her head and breaks the line of sight between one of the light beacons 110 and the wearable audio device 102, then the user's head would not be tracking the audio correctly any longer. In that situation, the spatialization adjustments could be handled by the IMU 216. So, the instantaneous shift of the image of the sound would be compensated or accounted for by the IMU 216 until a line of sight and a new reading of the beacon 110 is established by the light angle sensor 214. In certain implementations, so long as one light angle sensor 214 maintains line of sight with both (all) of the light beacons 110, the information derived from that sensor can be shared between the earpieces 106. However, in implementations in which only one light angle sensor 214 is used and it loses lines of sight with the light beacons or where both (all) light angle sensors lose line of sight with one or more of the light beacons, then the earpieces 106 may implement a relay process that would switch between the absolute position being sensed by the light angle sensor(s) 214 and the relative position being monitored by a local accelerometer, gyroscope or any other inertial measurement system.

In some cases, the system 100 can support one or more additional users, also wearing a wearable audio device(s). For example, FIG. 3B illustrates a second user 300′ wearing a second wearable audio device 102′ that includes a pair of light angle sensors 214a′, 214b′ (collectively “light angle sensors 214′). The light angle sensors 214′ on the second wearable audio device 102′ similarly detect the light beams 108 emitted by the light beacons 110 to provide the angle of incidence between each of the two beams 110 and each of the two light angle sensors 214′. And, as with the first wearable audio device 102, the second wearable audio device 102′ uses the incident angles and the known distance between the two light beacons 110a, 110b to determine appropriate HRTFs in order to render one or more virtual audio sources at desired locations; i.e., rendered such that the virtual audio source(s) 114 are perceived, to the second user 300′, as though they are located at the desired locations.

In an example in which the source device 104 is a soundbar and the wearable audio devices 300, 300′ are open-ear headphones that are used to provide virtualized rear surround speakers, the virtual audio sources 114 (virtual speakers) can be rendered such that they are perceived as being located in the same fixed location, relative to the source device 104, within the listening environment E to both users 300, 300′. This can allow the users to have a shared experience. While two users and two wearable audio devices are shown, additional users with additional wearable audio devices may also be supported.

In another implementation, the source device 104 may be an instrument panel in a cockpit of an airplane. The wearable audio device(s) may render virtual audio sources perceived as being located at one or more points on the instrument panel. In some cases, in addition to the audio signal 112, the source device 104 may also provide location data (e.g., metadata) related to the desired location of the virtual audio source to the wearable audio device(s). For example, the spatial rendering may be used to make notifications, e.g., alarms or warning sounds, sound as though they are originating from a particular instrument or gauge on the instrument panel. This can be beneficial to help steer the user's attention to an area of interest or concern. The source device 104 may provide information (location data) to the wearable audio device that identifies a fixed location, relative to the source device, or a particular gauge or instrument, or a particular audio channel that informs the wearable audio device 102 either where to locate the virtual audio source(s) or which virtual audio source(s) of a set of one or more predetermined virtual audio source(s) is/are to render the modified (processed) audio signal.

According to yet another implementation, the source device 104 may be a vehicle dashboard or a rear seat in a vehicle. In the case of a dashboard, the system may be configured to render the virtual audio sources to steer the user's attention in a particular direction, e.g., to direct the user's attention to an instrument or gauge on the dashboard, or to provide additional directional guidance during guided navigation. Alternatively, in the case of a rear seat in the vehicle, the system 100 may be used to provide individualized listening zones. That is, each user that has a wearable audio device can listen to the audio content of their choice without disturbing others. The audio can be rendered, via the wearable audio device(s), to sound as though it is coming from the vehicle's audio system, e.g., from the peripheral speakers in the vehicle.

In yet another implementation, the source device 104 may be a gaming console or a conferencing device. The wearable audio device(s) may be used to render virtual audio sources that are perceived to the user as originating either from the gaming console or conferencing device itself or from a screen or monitor associated with the gaming console or conferencing device. The source device 104 can provide data to locate the one or more virtual audio sources at particular locations on the screen/monitor. For example, in the case of the conferencing device, the system may be configured such that the virtual audio source is perceived by the user as coming from a location on the screen/monitor that corresponds to a position of another conference participant.

While implementations have been described in which the source device 104 provides the audio signal 112 and location data 302, in some implementations, an other device (e.g., a peripheral device, such as a smart phone or tablet) in the environment E can provide the audio signal and/or location data. For example, in some instances the source device 104 may be a display device (e.g., a computer monitor or a television) that includes the light angle sensors and the audio signal may be provided to the wearable audio device (e.g., directly) from a separate audio source. The separate audio source might also provide a video signal to the source device.

Furthermore, while implementation have been described which include two light beacons (e.g., at a certain distance from each other and within a target acoustical plane), some implementations may include more light beacons. For example, some implementations may include a third light beacon that can be used for 3-dimensional (3D) sensing. That is, in addition to sensing head pan angle (e.g., in a 2D plane), a third light beacon can be used to help detect head elevation angle (vertical tilt). Such implementations may require not only a third, but at least two light angle sensors-one for measuring horizontal head pan angle and another for measuring head elevation angle.

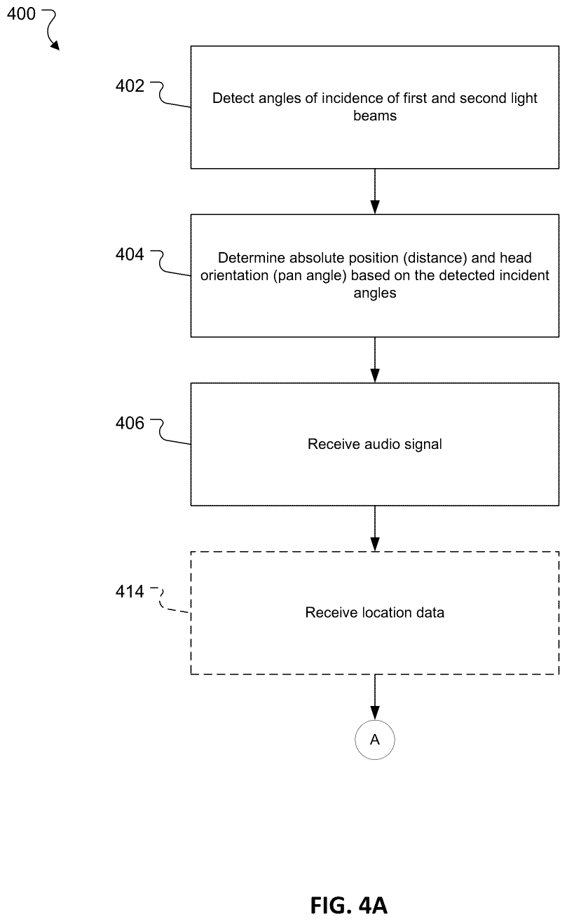

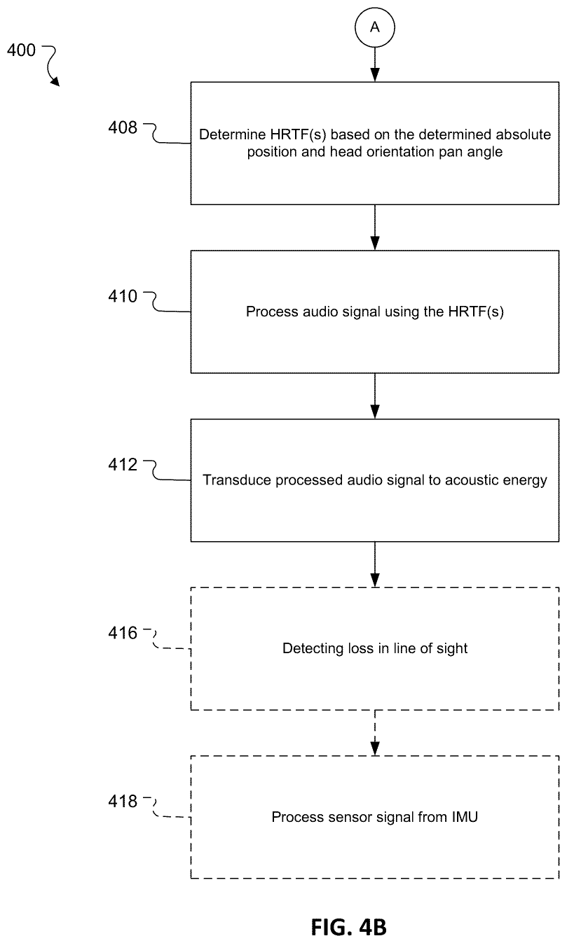

FIGS. 4A & 4B illustrate an exemplary flow chart showing the steps of method 400 according to the present disclosure. Method 400 includes, for example: detecting 402, at a light angle sensor 214 of a wearable audio device 102, an angle of incidence of a first light beam 108a (e.g., a first IR light beam) emitted from a first light emitter (beacon) 110a of a source device 104 and an angle of incidence of a second light beam 108b emitted from a second light emitter (beacon) 110b of the source device 104; and determining 404, via a processor 202, an absolute position (distance) and a head orientation of a user relative to the source device 104 based on the detected incident angles and a known distance between the first and second light beacons 110a, 110b. The method 400 also includes receiving 406 an audio signal 112; determining 408, using the processor 202, an HRTF based on the determined absolute position (distance) and head orientation (pan angle); and processing 410 the audio signal 112 using the HRTF, via the processor 202, to provide a processed audio signal 402. The method 400 can also include transducing 412 the processed audio signal to acoustic energy using one or more transducers 212 of the wearable audio device 102 to provide spatialized audio that is perceived by the user to originate from one or more virtual audio sources 114. The audio signal 112 may be provided (transmitted) to the wearable audio device 102 by the source device 104 or by an other device (e.g., a peripheral device such as a mobile phone or table) in the environment E.

In some cases, the wearable audio device 102 may also receive 414 (from the source device 104 or an other device in the environment E) location data 302 corresponding to an intended location of the one or more virtual audio sources 114, e.g., relative to the source device 104, and the HRTF(s) may be selected based, in part, on the location data. In some cases, the audio signal 112 may be divided into multiple audio channels and the location data may relate to the corresponding audio channel(s). In some cases, the wearable audio device 102 may be pre-programmed to render audio so as to be perceived to the user to originate from one or more virtual audio sources, wherein the perceived locations of the virtual audio sources, relative to the source device 104, are pre-determined. In certain cases, the pre-determined locations of the virtual audio sources correspond to different audio channels. For example, the source device 104 may provide one or more audio signals 112 corresponding to different audio channels along with metadata identifying the corresponding audio channel for each audio signal. The wearable audio device 102 may use the metadata to render audio such that it is perceived by the user as originating from a virtual audio source 114 associated with the corresponding audio channel. This may be used, for example, to simulate 5.1 audio where the wearable audio device 102 receives audio signals corresponding to rear right and rear left audio channels from the source device 104 and uses those audio signals, and corresponding metadata, to render virtual rear surround audio sources. Alternatively, or additionally, the source device 104 may provide metadata that identifies (e.g., via a set of coordinates) a fixed position, relative to the source device 104, of a virtual audio source.

The method may be performed, e.g., contemporaneously, for each of two earpieces of the wearable audio device, where each earpiece is provided with a corresponding light angle sensor 214, processor 202, memory 204, and transducer 212.

The method 400 may also include detecting 416 a loss in line of sight between the light angle sensor 214 and at least one of the light beams 108, and, in response, processing 418, with the processor 202, a sensor signal from the IMU 216 to measure head movements and using the measured head movements to determine an HRTF(s) until the line of sight between the light angle sensor 214 and the two light beacons 110a, 110b is re-established. The HRTFs determined during this period may similarly be used to process, via the processor 202, the audio signal 112 to provide a processed audio signal that is transduced, via the transducer 212, into acoustic energy that is rendered such that it is perceived by the user as originating from the virtual audio sources.

### Other implementations

Although implementations have been described in which derived angle information (incident angle) is applied at a wearable audio device for spatial rendering, in some implementations, the derived angle information can be applied partially in the sound bar and partially in the wearable audio device.

While implementations have been described in which one or more light angle sensors are provided on a wearable audio device which detect light beams emitted by light beacons on a source device, in some implementations, the one or more light angle sensors may be provided on the source device and the light beacons may be provided on the wearable audio device. In such implementations, the source device can share (e.g., transmit) information regarding the detected absolute position and/or measured incident angles with the wearable audio device, e.g., so that the wearable device can select the appropriate HRTFs and/or the source device may determine the appropriate HRTFs and provide (e.g., transmit) those to the wearable audio device.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A wearable audio device, comprising:
a light angle sensor configured to measure respective angles of incidence of a pair of light beams emitted by respective light beacons associated with a source device,
wherein the wearable audio device is configured to use the measured angles of incidence for spatial audio rendering.

2. The wearable audio device of claim 1, wherein the wearable audio device is configured to use the measured angles of incidence for detecting the absolute position of the source device.

3. The wearable audio device of cl aim 1, wherein the source device is a playback device.

4. The wearable audio device of claim 1, wherein the wearable audio device is configured to use the measured angles of incidence for detecting a position of the light angle sensor relative to an absolute location within an acoustical space to render physically or psychoacoustical accurate audio queues.

5. The wearable audio device of claim 1, wherein the wearable audio device is configured to use the measured angles of incidence for object oriented spatial audio rendering (placing objects (virtual audio sources) in an absolute place relative to the beacons).

6. A system comprising:
a source device with a pair of light beacons; and
a wearable audio device configured to receive an audio signal from the source device,
wherein the wearable audio device is configured to process the audio signals based, at least in part, on information derived from light beams emitted by the light beacons.

7. The system of claim 6, wherein the source device comprises three light beacons for 3-dimensional sensing.

8. The system of claim 6, wherein the light beacons are infrared light emitters.

9. The system of claim 6, wherein the light beacons are arranged a fixed distance from each other on the source device.

10. The system of claim 6, wherein the source device is a soundbar.

11. The system of claim 6, wherein the system is a conferencing system.

12. The system of claim 6, wherein the source device is a display (e.g., a monitor or television).

13. The system of claim 6, wherein the system is an aviation system.

14. The system of claim 13, wherein the source device is an instrument panel within a cockpit of an aircraft.

15. The system of claim 6, wherein the system is disposed within an automobile.

16. The system of clam 6, wherein the system is a gaming system.

17. A system comprising:
a wearable audio device comprising a light angle sensor; and
a source device configured to transmit an audio signal to the wearable audio device,
wherein the wearable audio device is configured to process the audio signal based, at least in part on information derived from the light angle sensor to provide spatial audio rendering.

18. The system of claim 17, wherein the wearable audio device comprises an open-ear earbud.

19. The system of claim 18, wherein the light angle sensor is supported on the open-ear bud.

20. The system of claim 17, wherein the wearable audio device comprises headphones comprising a pair of earcups connected to each other by a band.
